(19) United States
(12) Patent Application Publication
(10) Pub. No.: US 2013/0064288 A1
(43) Pub. Date: Mar. 14, 2013

(54) SECURED CONTENT DISTRIBUTION

(71) Applicants: Anatoly Adolf Fradis, Beverly Hills, CA (US); John Vulich, Studio City, CA (US)

(72) Inventors: Anatoly Adolf Fradis, Beverly Hills, CA (US); John Vulich, Studio City, CA (US)

(21) Appl. No.: 13/665,082

(22) Filed: Oct. 31, 2012

Related U.S. Application Data
(62) Division of application No. 12/875,520, filed on Sep. 3, 2010.

(51) Int. Cl. H04N 11/02

(52) U.S. Cl. 375/240.02; 375/E07.026

(57) ABSTRACT

The illustrative embodiments described herein provide a computer implemented method for encoding electronic media. An encoding process of the electronic media is initiated at an initial bit rate. The initial bit rate is increased to a baseline bit rate over a predetermined period of time. The baseline bit rate is varied in response to at least one of a density of detail, a delta pixel threshold, and a predominant color.

### CROSS-REFERENCE TO RELATED APPLICATIONS

This application is a divisional of U.S. patent application Ser. No. 12/875,520, filed on Sep. 3, 2010, which is incorporated herein by reference.

### BACKGROUND

1. Field of the Invention

The present invention relates generally to managing data. Still more particularly, the present invention relates to a computer implemented method for encoding electronic media.

2. Description of the Related Art

Electronic media is data that is accessible by a consumer through the use of electronic devices. Consumers access electronic media for many purposes, including but not limited to educational, informational, or recreational endeavors. In many instances, electronic media includes both audio content and video content, and is in either digital or analog form. Non-limiting examples of electronic media may include news broadcasts, television programs, sports telecasts, movies, and music.

In the past, one predominant method of electronic media distribution was via radio waves that could then be presented to consumers on television sets and radios. Another popular distribution method of electronic media was, and still is, the sale or rental of recordable type media, such as VHS tapes, DVDs, CDs, and cassettes, on which the electronic media is stored. More recently, however, the streaming of digital electronic media over internet is growing in popularity. Streaming is a method of distributing electronic media from a server application, which is received and presented in real-time by a client application. Electronic media that is streamed to a client computer is simultaneously downloaded and viewed without leaving a copy of the physical file on the client computer.

### BRIEF SUMMARY

The illustrative embodiments described herein provide a computer implemented method for encoding electronic media. An encoding process of the electronic media is initiated at an initial bit rate. The initial bit rate is increased to a baseline bit rate over a predetermined period of time. The baseline bit rate is varied in response to at least one of a density of detail, a delta pixel threshold, and a predominant color.

### BRIEF DESCRIPTION OF THE SEVERAL VIEWS OF THE DRAWINGS

FIG. 1 is a representation of a network of data processing systems in which illustrative embodiments may be implemented;

FIG. 2 is a block diagram of a data processing system in which illustrative embodiments may be implemented;

FIG. 3 is a block diagram of a system for securing streaming media in accordance with an illustrative embodiment;

FIG. 4 is a flowchart of a high level process for securing electronic media in accordance with an illustrative embodiment;

FIG. 5 is a flowchart of a process for securing electronic media in accordance with an illustrative embodiment;

FIG. 6 is a flowchart of a process for encoding source material in accordance with an illustrative embodiment; and

FIG. 7 is a flowchart of a variable bit rate encoding process in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, laser, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

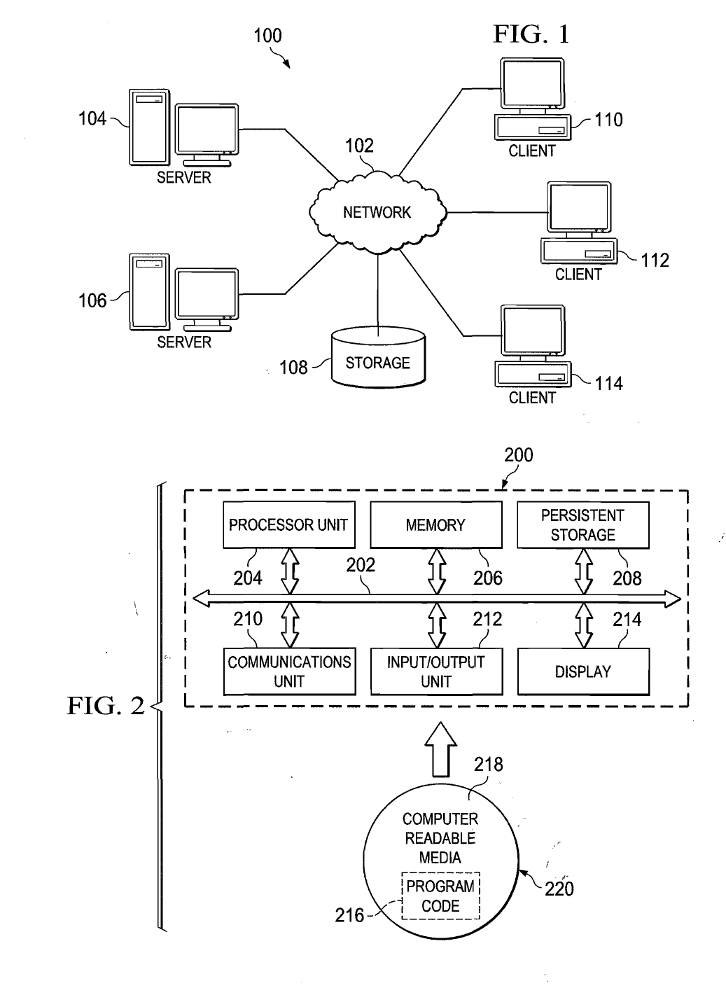

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments may be implemented. Network data processing system 100 is a network of computers in which the illustrative embodiments described herein may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In an illustrative example, server 104 hosts an encoding system for compressing electronic media. The encoding system implements a variable bit rate compression algorithm for optimizing the audio/video content quality to media file size ratio. The compressed electronic media is then stored in storage 108 until the compressed electronic media is requested by a client, such as client 110. In this example, client 110 is a combination playback device and viewer, such as in the case where client 110 is a personal computing device or a smartphone. Client 110 hosts a security module that decrypts, authenticates, watermarks, and secures the electronic media before making the electronic media available to a user on a viewer.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The production of electronic media desirable to viewers and consumers often requires numerous individuals and organizations to invest time, talents, and financial resources. For example, creating a movie or television program requires screenwriters, producers, a cast and crew, editors, and participation from various unions. Budgets are often exceeded, and profit margins are typically tight. Unauthorized access and copying of electronic media may reduce box office earnings, advertising revenues, and DVD sales, further reducing profits.

The distribution of screeners is another area in which secured distribution of electronic media is relevant and indispensable. A screener is an advance screening of a film sent to critics, awards voters, the Academy of the Motion Pictures Arts and Science, the Director's Guild, the Screen Actor's Guild, and the Television Academy, and other film industry professionals, including producers and distributors. In many instances, screeners have yet to be released and are therefore highly sought after by members of the public. Unauthorized access and copying of screeners may result in negative financial repercussions.

The illustrative embodiments disclosed herein relate to a content distribution system for securing electronic media. The content distribution system utilizes server side encryption and client side decryption by authorized playback devices as a layer of content protection. In addition, secured password authentication is implemented to prevent users from accessing the protected electronic media on an unauthorized playback device. Forensic watermarking technology is also implemented to facilitate the identification of unauthorized copies of secured electronic media and to assist in the apprehension of infringers. In addition, HDCP copy protection and analog copy protection may be implemented to protect against the interception and unauthorized copying of electronic media outputted from a playback device. The novel combination of security features disclosed herein provides a content distribution system that is superior to currently used content distribution systems, which may implement one or two of the above-referenced protection mechanisms, but fail to provide a system that adequately deters and prevents the unauthorized access and copying of electronic media.

One consequence of implementing a content protection system having a series of security protocols as disclosed herein relates to the increased processor burden on both the server side and client side. As a result, a variable bit rate encoding process is implemented for optimizing the encoding of electronic media for online distribution. It will be appreciated by one skilled in the art that the words “optimize” and “optimization,” and related terms are terms of art that refer to improvements in speed, efficiency, and/or any other specified outcome and do not purport to indicate that a process for achieving the specified outcome has achieved, or is capable of achieving, an “optimal” or perfect state as defined by relevant criteria.

As used herein, optimizing the encoding process means the generation of electronic media that has a higher quality to size ratio than currently existing content distribution systems, and decreases the bandwidth requirements for both the host and client. A benefit of decreased bandwidth requirement decreases the occurrence of stuttering and buffering of the electronic media during playback. Another benefit is decreased bandwidth costs for the operator of the media distribution service.

Optimization is achieved, in part, by implementing a variable bit rate encoding process that begins at an initial bit rate and increases to a baseline bit rate over a predetermined period of time. The baseline bit rate varies based upon an amount of delta pixels detected, and a detail density detected. In addition, the variable bit rate encoding process also changes according to a predominant color detected in a set of frames.

In accordance with the foregoing, the embodiments disclosed herein recognize the benefits of a series of security protocols for use in distributing electronic media. Thus, the disclosure provides for a computer implemented method, apparatus, and computer program product for securing streaming electronic media. A playback device is authenticated for receiving encrypted electronic media from a content server. The encrypted electronic media received by the playback device is decrypted to form decrypted electronic media. The decrypted electronic media is imprinted with a set of watermarks to form imprinted electronic media. An output of the imprinted electronic media is secured using at least one of high-bandwidth digital content protection or analog copy protection.

As used herein, the term “at least one of”, when used with a list of items means that different combinations of one or more of the items may be used and only one of each item in the list may be needed. For example, “at least one of item A and item B” means either item A, item B, or both items A and B. Thus, securing electronic media using at least one of high-bandwidth digital content protection or analog copy protection means that electronic media is secured using either the high-bandwidth digital content protection or analog copy protection or both either the high-bandwidth content and the analog copy protection.

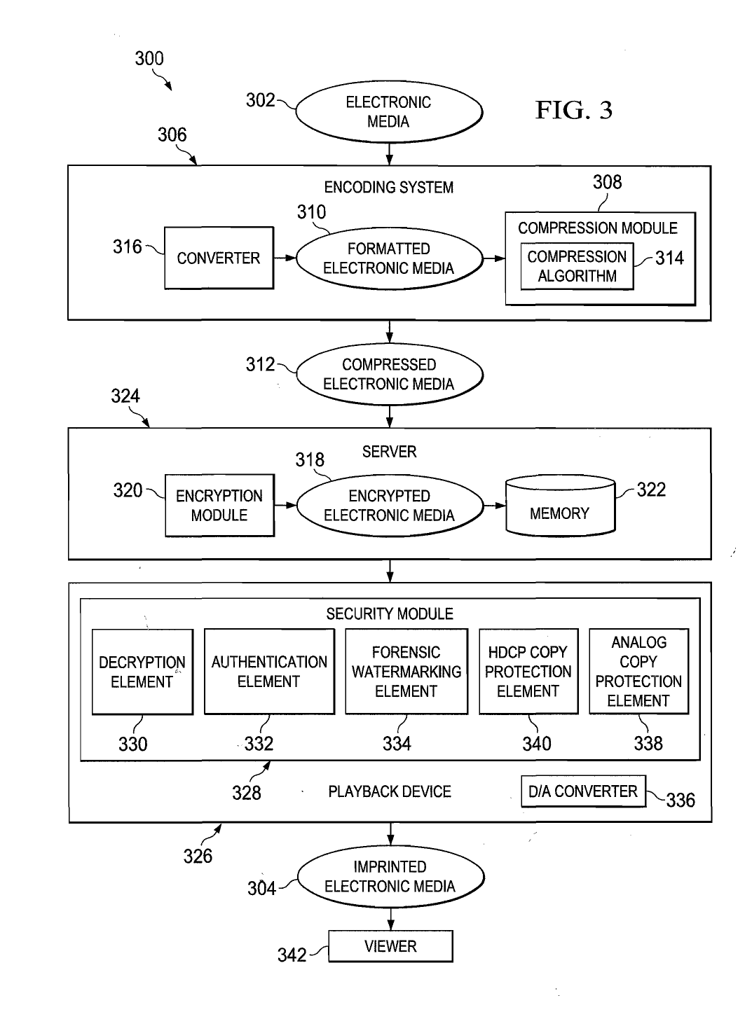

FIG. 3 is a block diagram of a system for securing electronic media in accordance with an illustrative embodiment. System 300 is a system such as network data processing system 100 in FIG. 1. System 300 is configured for securing electronic media 302 for distribution. Electronic media 302 is media that includes audio content and/or visual content which is accessible through the use of electronic devices. Electronic media 302 may originate from any type of audiovisual media, including but not limited to analog video tape, analog audio tape, digital video tape, digital audio tape, DVD, CD, live terrestrial television broadcasts, live cable television broadcasts, live satellite television broadcasts, or live video input.

The operation of system 300 transforms electronic media 302 into imprinted electronic media 304. Imprinted electronic media 304 is electronic media, derived from electronic media 302, which is compressed and protected from unauthorized access and reproduction by the series of security features disclosed herein. In particular, imprinted electronic media 304 includes an embedded forensic watermark, and is authorized to play on a limited number of playback devices. Furthermore, imprinted electronic media 304 is secured from unauthorized reproduction by high-bandwidth digital content protection and/or analog copy protection mechanisms.

Before converting electronic media 302 to imprinted electronic media 304, electronic media 302 is processed by encoding system 306. Encoding system 306 is a system including hardware and/or software for encoding electronic media 302. Encoding system 306 includes compression module 308. Compression module 308 is a software component of encoding system 306 that encodes electronic media 302 to form compressed electronic media 312. Compressed electronic media 312 is a compressed version of media generated from electronic media 302.

Compression module 308 encodes electronic media 302 according to compression algorithm 314. Compression algorithm 314 is a set of rules governing the video and/or audio compression of electronic media 302. Compression algorithm 314 also includes any tables, equations, or other relationships referenced by the set of rules specified therein. In an illustrative embodiment, compression algorithm 314 specifies a baseline bit rate at which compression module 308 encodes a video stream of electronic media 302 in the absence of any mitigating factors. In addition, compression algorithm 314 specifies an initial bit rate at which compression module 308 begins encoding of electronic media 302, and a predetermined period of time for ramping up the encoding of electronic media 302 from the initial bit rate to the baseline bit rate. In this embodiment, the predetermined period of time corresponds to a title screen or opening credits of a movie or program. This controlled increase of the encoding bit rate from the initial bit rate to the baseline bit rate over the predetermined period of time has the effect of reducing bandwidth overhead by reducing the amount of encoded data, which allows a memory buffer to store more relevant information in less time. As a result, a data stream will be less likely to experience disruptions due to decreased bandwidth.

Compression algorithm 314 may also specify other criteria, such as density of detail, delta pixel levels, color predominance, and associated thresholds or relationships for varying the baseline bit rate in an attempt to optimize the encoding of electronic media 302. For example, in an illustrative embodiment, compression algorithm 314 specifies a set of detail density thresholds and a set of delta pixel thresholds. The set of detail density thresholds dictate the variability of the baseline bit rate based upon a level of detail detected in each frame. For example, as the density of detail increases, the variable bit rate may be increased from the baseline bit rate in relation to the level of detail present. Similarly, as the density of detail decreases, the variable bit rate may be decreased in relation to the level of detail present. A density of detail could be determined by determining a number of uniquely colored pixels. In one embodiment, a large number of uniquely colored pixels represents a high density of detail, whereas a small number of uniquely colored pixels represents a low density of detail. Compression algorithm 314 specifies the relationship between the density of detail and the corresponding variation in the baseline bit rate.

As used herein, delta pixels describe a number of pixels that change between frames. In an illustrative embodiment, delta pixels may be determined with respect to a number or percentage of pixels that change in one macroblock from one frame to the next. A macroblock is a group of adjacent pixels that generally form a rectangle. Thus, the set of delta pixel thresholds dictate the variability of the baseline bit rate based upon a comparison of pixels between successive frames. As the delta pixels detected between frames increases, the variable bit rate increases from the baseline bit rate to accommodate the increased information that must be encoded. As delta pixels decrease, the variable bit rate decreases from the baseline bit rate. Compression algorithm 314 specifies the relationship between the density of detail and the corresponding variation in the baseline bit rate.

Compression algorithm 314 also includes a color-dependent parameter for varying the baseline bit rate. Specifically, during the encoding process, compression module 308 monitors each frame that forms the video stream of electronic media 302 and identifies one or more predominant colors in each frame. The predominant colors may either be a color that is the most prevalent in the frame, or may be the color or colors which exceed a predetermined threshold. The threshold may be identified in any manner, such as a percentage or number of pixels. In one embodiment, compression module 308 refers to a lookup table in compression algorithm 314 for determining the variation of the baseline bit rate according the predominant color detected in one or more successive frames. For example, compression module 308 may determine that a series of successive frames in electronic media 302 depicting a snowy mountain scene at night may have a predominant color of white, or black, or white and black depending upon the criteria set forth in compression algorithm 314.

Although the illustrative embodiments disclosed hereinabove are described as thresholds that govern the variability of the encoding bit rate, in other embodiments, the baseline bit rate may vary continuously in relation to a real time values for the delta pixel level, the detail densities detected in each frame, and the color dependency. Thus, instead of maintaining the baseline bit rate until a threshold is met or exceeded, the baseline bit rate may continuously fluctuate up and down based upon real time monitored values for density of detail, delta pixel levels, and predominant colors present in each frame.

Compression module 308 utilizes noise shaping for encoding the audio components of electronic media 302. Noise shaping is the process by which imperceptible audio is encoded during the formation of compressed electronic media 312. Imperceptible audio is one or more sounds which is inaudible to humans. Audio may be inaudible to humans for various reasons. For example, audio may be imperceptible because the frequency is too high or too low to be detected by human ears. In addition, audio that would be otherwise detectible by humans may be considered imperceptible because the audio occurs concurrently with a louder audio event. For example, the sound of footsteps occurring contemporaneously with an explosion may be determined to be imperceptible audio because the sound of the explosion would mask the sound of the footsteps. Thus, the process of noise shaping would either refrain from encoding the footsteps, or would encode the footsteps with fewer bits under the assumption that the degraded audio quality with respect to the footsteps would be imperceptible and therefore inconsequential. Parameters governing noise shaping may be set forth in compression algorithm 314.

In some instances, electronic media 302 is in a format that is incompatible with compression module 308. Thus, compression module 308 may be unable to encode electronic media 308 unless electronic media 302 is first converted to formatted electronic media 310. Formatted electronic media 310 is media derived from electronic media 302, but which is reformatted into a format compatible with compression module 308. Formatted electronic media 310 is generated by converter 316. Converter 316 is a component of encoding system 306 for converting electronic media 302 into formatted electronic media 310. For example, if electronic media 302 is in an analog format, converter 316 may be an audio/digital converter for converting electronic media 302 to a digital format that is compatible with compression module 308. In addition, if electronic media 302 is in a digital format incompatible with compression module 308, then converter 316 may convert electronic media 302 from the incompatible digital format to a compatible digital format that may be processed by compression module 308.

Compressed electronic media 312 is stored as encrypted electronic media 318. Encrypted electronic media 318 is compressed electronic media that has been encrypted using currently existing or later developed encryption techniques. In this illustrative embodiment in FIG. 3, encrypted electronic media is encrypted by encryption module 320. Encryption module 320 is software for encrypting compressed electronic media 312. In this illustrative embodiment in FIG. 3, encryption module 320 utilizes 128 bit AES encryption. However, in alternate embodiments, other forms of symmetric-key or asymmetric encryption may also be used.

Encrypted electronic media 318 is stored in memory 322. Memory 322 is a storage device for storing data. Memory 322 may be, for example and without limitation, a portable computer diskette, a hard disk, a random access memory, a read-only memory, an erasable programmable read-only memory, an optical storage device, a magnetic storage device, or any suitable combination of the foregoing. In this illustrative embodiment, memory 322 is housed in server 324. Server 324 is one or more servers such as server 104 in FIG. 1.

Server 324 streams encrypted electronic media 318 to a playback device 326 when encrypted electronic media 318 is requested. Playback device 326 is a computing device such as client 110 in FIG. 1, and has hardware and/or software for processing encrypted electronic media 318 received from server 324. Examples of playback device 326 may include, for example and without limitation, a set top box, a desktop computer, laptop computer, tablet computer, and a smartphone.

Security module 328 is a software and/or hardware component of playback device 326 for processing encrypted electronic media 318 for playback. Security module 328 includes authentication element 332 for authenticating playback device 326. Authentication of playback device 326 may be accomplished by any currently existing or later developed means. In one non-limiting example, authentication element 332 negotiates a handshake between playback device 326 and server 324 using a unique identifier assigned to or otherwise associated with playback device 326. The handshake confirms that the unique identifier of playback device 326 is matched to a data key stored on server 324. The unique identifier may be, for example and without limitation, a MAC address of playback device 326, a component serial number of playback device 326, or any other unique identifier assigned to playback device 326.

Security module 328 includes decryption element 330. Decryption element 330 is software for decrypting encrypted electronic media 318. The method by which decryption element 330 operates is dictated by the manner in which the encryption mechanism of system 300 is configured. For example, in this illustrative embodiment system 300 implements symmetric key encryption/decryption. Consequently, decryption element 330 performs symmetric key decryption. However, decryption element 330 may also perform any or all other forms of decryption that may be utilized by system 300.

After decryption and decoding by the relevant codec in preparation for playback, forensic watermarking element 334 embeds a watermark into the decrypted electronic media to form imprinted electronic media 304. Forensic watermarking element 334 is a software component of security module 328 that imprints a set of watermarks into the decrypted electronic media. The set of watermarks is one or more watermarks which includes a unique identifier for identifying playback device 326 as the device to which encrypted electronic media 318 was delivered. The unique identifier may be generated from a unique identifier of playback device 326, such as, for example, a serial number, user identifier, or MAC address of playback device 326. The forensic watermark can be extracted from an unauthorized copy of secured electronic media 304 to ascertain the origin of the infringing copy.

In one embodiment, the set of watermarks may be imprinted into a video stream of the decrypted electronic media. In particular, one or more frames that form the set of watermarks may be inserted throughout into the video stream of the decrypted electronic media so that the set of watermarks may be detected by monitoring equipment. The placement of individual frames throughout the video stream would insure that the set of watermarks would be undetectable by human viewers during playback of imprinted electronic media 304.

Once the set of watermarks have been imprinted into the decrypted electronic media to form imprinted electronic media 304, high-bandwidth digital content protection and/or analog copy protection mechanisms are implemented for securing imprinted electronic media 304 from unauthorized copying.

Analog copy protection element 338 is a software component of security module 328 that secures the analog signal output from playback device 326 to prevent copying. Analog copy protection element 338 operates generally by embedding visual artifacts into the analog output that is affects recording devices but not viewing devices. Analog copy protection element 338 may be any currently existing or later developed form of analog copy protection. Non-limiting examples of analog copy protection programs that may serve as analog copy protection element 338 include versions of the legacy analog copy protection offered by Macrovision™, or a form of the copy generation management system—analog (CGMS-A) copy protection mechanism that embeds a waveform into the vertical blanking interval (VBI) of the analog signal outputted from playback device 326.

D/A converter 336 is a digital to analog converter for converting a digital copy of imprinted electronic media 304 into analog format for outputting from one or more analog outputs of playback device 326. The analog outputs originating from playback device 326 may include a composite output, a component output, or an S-video output. D/A converter 336 may be necessary for converting imprinted electronic media 304 from a digital format to an analog format for viewing on certain viewing devices.

HDCP copy protection element 340 is a hardware and/or software component of security module 328 that provides high-bandwidth digital content protection. In particular, HDCP copy protection element 340 secures the digital output from playback device 326 by authenticating any device receiving digital output from playback device 326. Authentication may be accomplished with reference to a unique identifier and related encryption data stored on the extended display identification data (EDID) chip of playback device 326. In one embodiment, a symmetric threshold key exchange protocol used in HDCP mechanisms that permits playback device 326 and any attached device to independently create a shared key for communicating using a secret key and public identifier provided by a trusted third party. HDCP copy protection element 340 enables the authentication of any device interfacing with playback device 326 and receiving digital output, thereby reducing the likelihood of unauthorized access or copying of imprinted electronic media 304.

Imprinted electronic media 304 is outputted to viewer 342. Viewer 342 is a hardware device for presenting imprinted electronic media 304 to a user for viewing. Imprinted electronic media 304 may be delivered from playback device 326 to viewer 342 by any currently existing or later developed data transfer means. For example, imprinted electronic media 304 in a digital format may be delivered from playback device 326 to viewer 342 via an HDMI interface. In the event that secured electronic media 304 is in analog form may be delivered from playback device 326 to viewer 342 by a composite, component, or S-video connector. Although viewer 342 is depicted as a standalone component of system 300, in an alternate embodiment, viewer 342 may be an integrated component of playback device 326. For example, where playback device 326 is a personal computer or smartphone, viewer 342 may be the monitor, touchscreen interface, or display device.

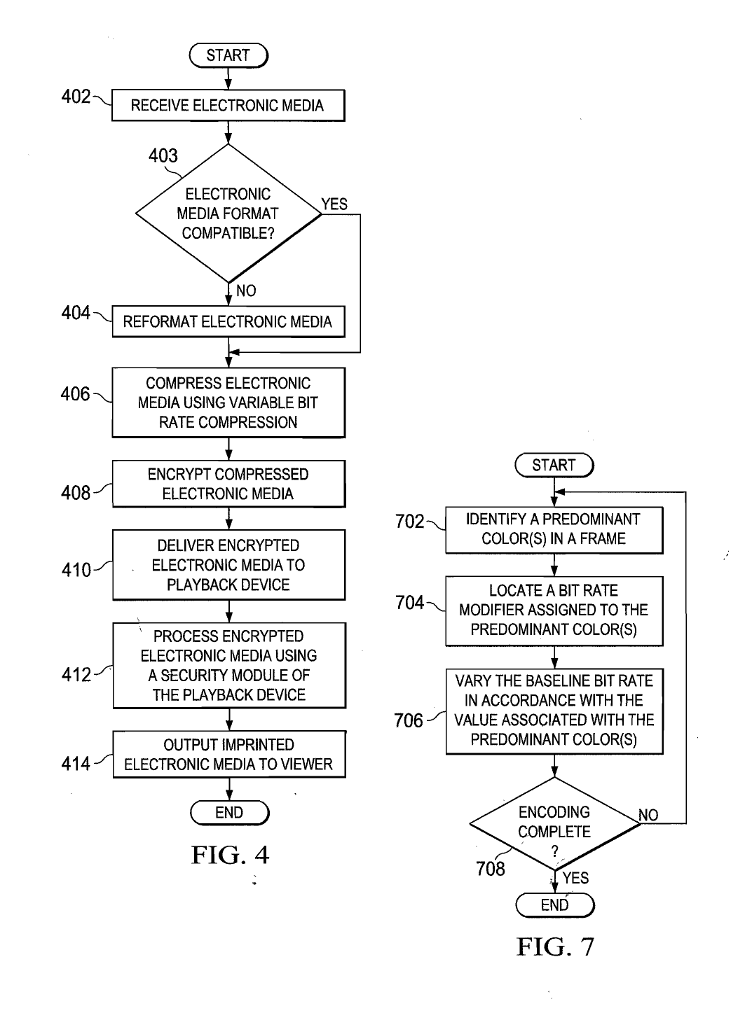

FIG. 4 is a flowchart of a high level process for securing electronic media in accordance with an illustrative embodiment. The process depicted in FIG. 4 may be performed by hardware and/or software components of a networked data processing system such as networked data processing system 300 in FIG. 3.

The process begins by receiving electronic media (step 402). A determination is then made as to whether the electronic media format is compatible (step 403). If the electronic media format is not compatible, then the electronic media is reformatted (step 404). The reformatted electronic media is then compressed using variable bit rate compression (step 406). If at step 403, the determination is made that the electronic media format is compatible with the encoding system, then the process continues directly to step 406.

Compressed electronic media is encrypted (step 408), and the encrypted electronic media is delivered to a playback device (step 410). The playback device is a playback device such as playback device 326 in FIG. 3.

The encrypted electronic media is processed by a security module in the playback device (step 412). The processing of the encrypted source material by the security module forms imprinted electronic media, which is outputted to a viewer (step 414) and the process terminates thereafter.

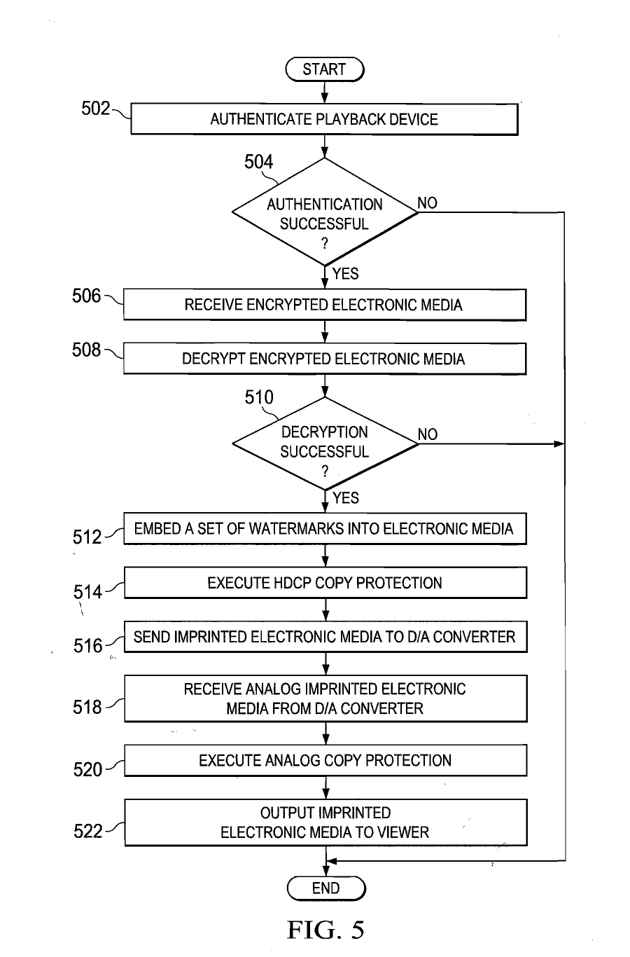

FIG. 5 is a flowchart of a process for securing electronic media for viewing in accordance with an illustrative embodiment. The process depicted in FIG. 5 may be implemented in one or more software components of a security module, such as security module 328 in FIG. 3.

The process begins by authenticating a playback device (step 502). A determination is made as to whether the authentication was successful (step 504). If the authentication was not successful, then the process terminates. However, if the authentication process was successful, then the process receives encrypted electronic media (step 506). The encrypted electronic media is received from a content server, such as server 324 in FIG. 3.

Decryption of the electronic media is attempted (step 508). A determination is then made as to whether decryption was successful (step 510). If decryption of the encrypted electronic media was not successful, then the process terminates. However, if decryption of the encrypted electronic media was successful, then a set of watermarks are embedded into the decrypted electronic media (step 512).

The imprinted electronic media is also secured against copying by implementing HDCP and analog copy protection. Thus, high-bandwidth digital content protection (HDCP) is executed (step 514). The imprinted electronic media is also sent to a D/A converter (step 516), and an analog version of the imprinted electronic media is received back from the D/A converter (step 518). Analog copy protection is executed (step 520). The imprinted electronic media is then securely outputted to a viewer via HDMI or analog connections (step 522), and the process terminates.

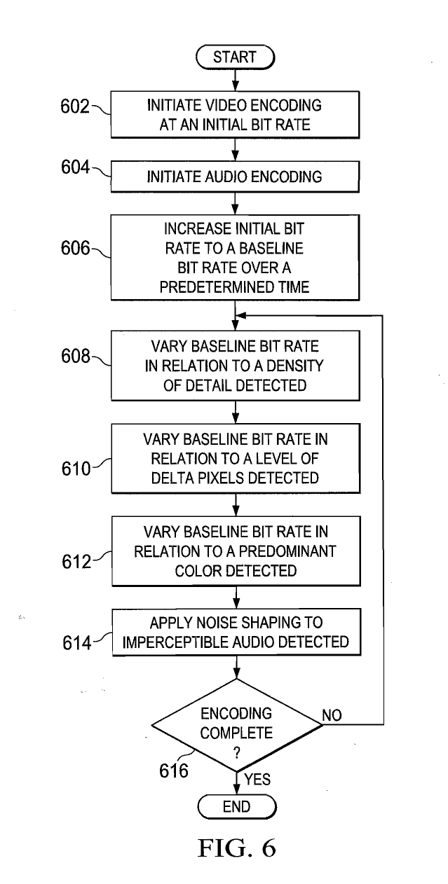

FIG. 6 is a flowchart of a process for encoding source material in accordance with an illustrative embodiment. The process depicted in FIG. 6 may be implemented in a software component of a compression module, such as compression module 308 in FIG. 3. Encoding parameters, such as an initial bit rate, a baseline bit rate, delta pixel thresholds, and detail density thresholds, may be specified by a compression algorithm such as compression algorithm 314 in FIG. 3.

The process begins by initiating video encoding at an initial bit rate (step 602). Audio encoding is also initiated (step 604). Thereafter, the initial bit rate is increased to a baseline bit rate over a predetermined time (step 606).

The baseline bit rate is varied in relation to a density of detail detected (step 608). The baseline bit rate is also varied in relation to a level of delta pixels detected (step 610). Furthermore, the baseline bit rate is varied in relation to a predominant color detected (step 612). Noise shaping also applied to any imperceptible audio that is detected (step 614).

A determination is made as to whether the encoding process is complete (step 616). If the encoding process is complete, the process terminates. However, if the encoding process is incomplete, then the process returns to step 608 and repeats until encoding is complete.

FIG. 7 is a flowchart of a process for a color dependant variability of an encoding process in accordance with an illustrative embodiment. The process depicted in FIG. 7 may be implemented in a software component of a compression module, such as compression module 308 in FIG. 3.

The process begins by identifying a predominant color in a video frame (step 702). A bit rate modifier assigned to the predominant color is located (step 704). The bit rate modifier may be located with reference to a compression algorithm, such as compression algorithm 314 in FIG. 3. The baseline bit rate is then varied in accordance with the bit rate modifier associated with the predominant color(s) (step 706).

A determination is then made as to whether the encoding is complete (step 708). If the encoding is complete, then the process terminates. However, if the encoding process is incomplete, then the process returns to step 702.

As discussed herein, the illustrative embodiments described herein provide a computer implemented method, apparatus, and computer program product for securing streaming electronic media. A playback device is authenticated for receiving encrypted electronic media from a content server. The encrypted electronic media received by the playback device is decrypted to form decrypted electronic media. The decrypted electronic media is imprinted with a set of watermarks to form imprinted electronic media. An output of the imprinted electronic media is secured using at least one of high-bandwidth digital content protection or analog copy protection.

The variable bit rate compression algorithm, which utilizes a color dependent variability, optimizes the ratio of the video and/or audio quality to file size ratio, and reduces bandwidth and processor requirements. As a result, playback of the secured electronic media results in a reduction of artifacts and decreases the strain on the processor.

Furthermore, the security module disclosed herein provides a series of security protocols that prevents unauthorized access and reproduction of streaming electronic media. In the event that otherwise permissive use has led to unauthorized reproduction of the secured electronic media, the imprinted watermark facilitates identification of the source of the secured electronic media, and consequently facilitates apprehension of the infringing party.

The flowchart and block diagrams disclosed herein illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for encoding electronic media, the computer implemented method comprising:
initiating an encoding process of the electronic media at an initial bit rate;
increasing the initial bit rate to a baseline bit rate over a predetermined period of time; and
varying the baseline bit rate in response to at least one of a density of detail, a delta pixel threshold, and a predominant color.

2. The computer implemented method of claim 1, wherein varying the baseline bit rate in response to the predominant color further comprises:
detecting, in a frame, a set of similarly colored pixels exceeding a color threshold to identify the predominant color;
locating a bit rate modifier assigned to the predominant color; and
varying the baseline bit rate according to the bit rate modifier.
